(19) United States
(12) Patent Application Publication
(10) Pub. No.: US 2024/0086242 A1
(43) Pub. Date: Mar. 14, 2024

(54) METHOD AND NON-TRANSITORY COMPUTER-READABLE STORAGE MEDIUM AND APPARATUS FOR ANALYZING ALGORITHMS DESIGNED FOR RUNNING ON NETWORK PROCESSING UNIT

(71) Applicant: Airoha Technology (Suzhou) Limited, Suzhou City (CN)

(72) Inventors: Lidong HU, Nanjing (CN); Fei YAN, Nanjing (CN)

(73) Assignee: Airoha Technology (Suzhou) Limited, Suzhou City (CN)

(21) Appl. No.: 18/117,204

(22) Filed: Mar. 3, 2023

(30) Foreign Application Priority Data
Sep. 9, 2022 (CN) 202211106235.X

(51) Int. Cl. G06F 9/50

(52) U.S. Cl. CPC G06F 9/5027

(57) ABSTRACT

The invention relates to a method, a non-transitory computer-readable storage medium, and an apparatus for analyzing an algorithm designed for running on a network processing unit (NPU). The method, which is performed by a processing unit, includes: loading and executing an executable program file on a virtual machine, which includes the algorithm that can be executed by the NPU; generating an instruction classification table during an execution of the executable program file, where the instruction classification table stores information about instructions that have been executed on the virtual machine, and which instruction category each instruction is related to; and generating an execution-cost statistics table according to the instruction classification table and an instruction cost table, thereby enabling the algorithm to be optimized according to content of the execution-cost statistics table.

### CROSS-REFERENCE TO RELATED APPLICATIONS

This application claims the benefit of priority to Patent Application No. 202211106235.X, filed in China on Sep. 9, 2022; the entirety of which is incorporated herein by reference for all purposes.

### BACKGROUND

The disclosure generally relates to algorithm optimization and, more particularly, to a method, a non-transitory computer-readable storage medium and an apparatus for analyzing algorithms designed for running on a network processing unit (NPU).

The NPU is an integrated circuit, which can be programmed by software dedicated in the networking equipment. An algorithm which runs on the NPU mainly includes varies functions of data packet processing for repeatedly receiving packets through one port, decapsulating packets in conformity to the reception protocol, processing data from the decapsulated ones, encapsulating the processed data into packets in conformity to the transmission protocol and transmitting the data packets out through another port. However, a developed algorithm may suffer from low execution efficiency. Therefore, it is desirable to have a method, a non-transitory computer-readable storage medium and an apparatus for analyzing algorithms designed for running on a NPU, which are used to find out bottlenecks in execution as a basis for further optimization.

### SUMMARY

The disclosure relates to an embodiment of a method for analyzing an algorithm designed for running on a network processing unit (NPU). The method, which is performed by a processing unit, includes: loading and executing an executable program file on a virtual machine, which includes the algorithm that can be executed by the NPU; generating an instruction classification table during an execution of the executable program file, where the instruction classification table stores information about instructions that have been executed on the virtual machine, and which instruction category each instruction is related to; and generating an execution-cost statistics table according to the instruction classification table and an instruction cost table, thereby enabling the algorithm to be optimized according to content of the execution-cost statistics table.

The instruction cost table stores multiple costs, in which each cost is related to a designated instruction category. The execution-cost statistics table stores a summarized cost of executed instructions for each instruction category.

The disclosure further relates to an embodiment of a non-transitory computer-readable storage medium having stored therein program code that, when loaded and executed by a processing unit, cause the processing unit to perform the above method for analyzing an algorithm designed for running on an NPU.

The disclosure further relates to an embodiment of an apparatus for analyzing an algorithm designed for running on an NPU to include a processing unit. The processing unit is arranged operably to: load and execute an executable program file on a virtual machine, which includes the algorithm that can be executed by the NPU; generate an instruction classification table during an execution of the executable program file, where the instruction classification table stores information about instructions that have been executed on the virtual machine, and which instruction category each instruction is related to; and generate an execution-cost statistics table according to the instruction classification table and an instruction cost table, thereby enabling the algorithm to be optimized according to content of the execution-cost statistics table.

Both the foregoing general description and the following detailed description are examples and explanatory only, and are not restrictive of the invention as claimed.

### BRIEF DESCRIPTION OF THE DRAWINGS

FIG. 1 is a schematic diagram of three stages for optimizing an algorithm according to some implementations.

FIG. 2 is a schematic diagram illustrating a passive optical network (PON) according to an embodiment of the present invention.

FIG. 3 is a block diagram of the system architecture of an Optical Network Unit (ONU) router according to an embodiment of the present invention.

FIG. 4 is a schematic diagram for processing messages according to an embodiment of the present invention.

FIG. 5 is a block diagram of the system architecture of an analysis equipment according to an embodiment of the present invention.

FIG. 6 is a schematic diagram showing the software architecture for a simulated instruction analysis according to an embodiment of the present invention.

FIG. 7 is a flowchart illustrating a method for analyzing an algorithm based on simulated instructions according to an embodiment of the present invention.

FIG. 8 is a schematic diagram illustrating the execution simulation in the virtual environment according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words described the relationship between elements should be interpreted in a like fashion (e.g., “between” versus “directly between,” “adjacent” versus “directly adjacent.” etc.)

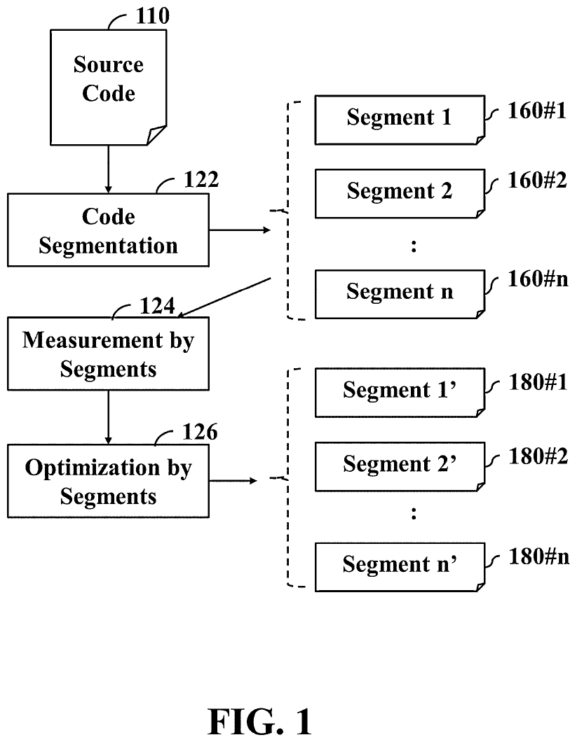

Refer to FIG. 1. In some implementations, the algorithm optimization is divided into three stages regularly: code segmentation 122; measurement by segment 124; and optimization by segment 126. In the first stage 122, the source code 110 composing software instructions of an algorithm may be divided into multiple segments 160 #1 to 160 #n in terms of various factors (e.g. functions), where n is an integer greater than 0. In the second stage 124, performance of each of the segments 160 #1 to 160 #n is measured. In the third stage 126, each of the segments 160 #1 to 160 #n is optimized according to its performance measurement, mainly by deleting redundant instructions to reduce the code path. However, the minimum unit of the above algorithm optimization is the line of code, which is not suitable for algorithms running on specific application equipment (such as Optical Network Unit-ONU router etc.). For example, reducing the code path reduces only the execution time of the processor, but does not necessarily improve the overall system performance of specific application equipment. Moreover, since the measurement by segment stage 124 requires to make each of the segments 160 #1 to 160 #n actually run on the target equipment (e.g. ONU router) to generate performance measurement results, the algorithm optimization cannot be performed without the target equipment.

To address the problems as described above, an embodiment of the present invention introduces an algorithm analysis method for the Network Processing Unit (NPU), which predicts the performance of the algorithm in advance based on the simulated execution of instructions. The method can be employed to optimize the algorithm according to the simulated execution results of instructions in the absence of the target device.

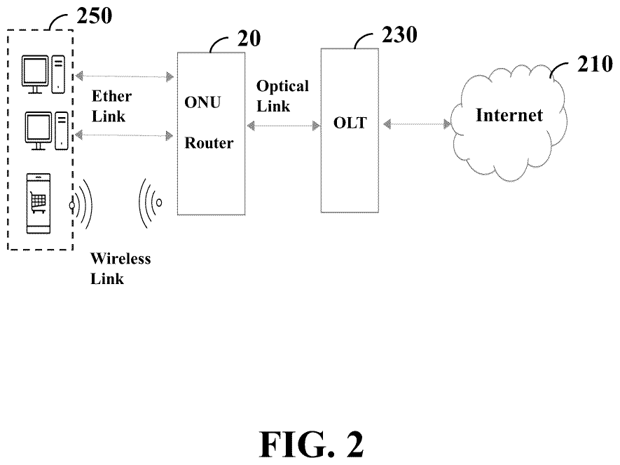

Refer to FIG. 2 showing a schematic diagram of a passive optical network (PON). The PON consists of the optical line terminal (OLT) 230 at the service provider's central control room, and a number of optical network units (ONUs), such as the ONU router 20. The OLT 230 provides two main functions: to perform conversion between the electrical signal used by the service provider's equipment and the fiber-optic signal used by the PON; and to coordinate the multiplexing between the ONUs on the other end of the PON. The OLT 230 and the ONU router 20 are connected to each other by an optical link. The ONU router 230 is a user-end equipment of the PON system, which can be installed in a home for interconnection with the user devices 250 using ether links and/or wireless links. The user device 250 may be a Personal Computer (PC), a laptop PC, a tablet PC, a mobile phone, a digital camera, a digital recorder, a smart television, a smart air conditioner, a smart refrigerator, a smart range hood, or other consumer electronic products. With the collocation of the OLT 230, the ONU router 20 provides various broadband services to the connected user devices 250, such as Internet surfing, Voice over Internet Protocol (VoIP) communications, high-quality video, etc.

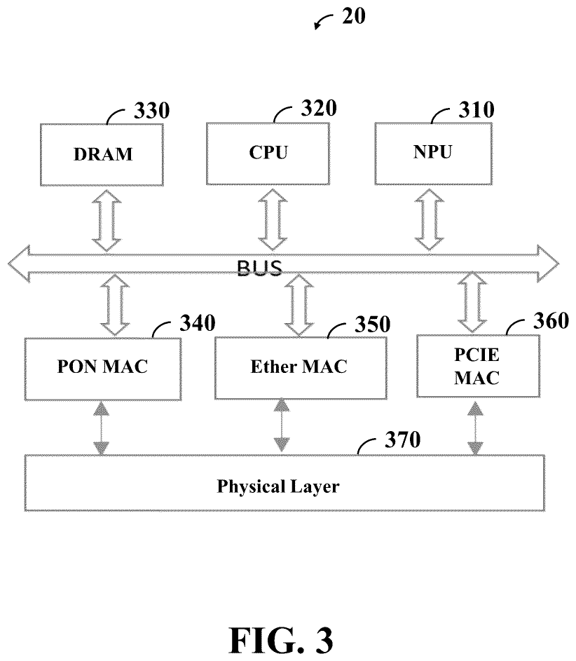

Refer to FIG. 3 showing the system architecture of the ONU router 20. The ONU router 20 includes the NPU 310, the Central Processing Unit (CPU) 320, the Dynamic Random Access Memory 330, the PON Media Access Control (MAC) 340, the Ether MAC 350, the Peripheral Component Interconnect Express (PCIE) MAC 360, which are coupled to each other by the shared bus architecture. The shared bus architecture facilitates the transmissions of data, addresses, control signals, etc. between the above components. The bus architecture includes a set of parallel physical-wires and is a shared transmission medium so that only two devices can access to the wires to communicate with each other for transmitting data at any one time. Data and control signals travel bidirectionally between the components along data and control lines, respectively. Addresses on the other hand travel only unidirectionally along address lines. For example, when the NPU 310 prepares to read data from a particular address of the DRAM 330, the NPU 310 sends this address to the DRAM 330 through the address lines. The data of that address is then returned to the NPU 310 through the data lines. To complete the data read operation, control signals are sent along the control lines.

The CPU 320 may be implemented in numerous ways, such as with general-purpose hardware (e.g., a single processor, multiple processors or graphics processing units capable of parallel computations, or others) that is programmed using software instructions to perform the functions recited herein. The NPU 310 is an integrated circuit which has a feature set specifically targeted at the networking application domain. The NPU 310 is a software programmable device, has generic characteristics similar to general purpose processing unit, and is are commonly used in processing packets interchanged between different types of networks, such as PON, Ethernet, Wireless Local Area Network (WLAN), Personal Access Network (PAN), and the like, for improving the overall performance of ONU router 20. The DRAM 330 allocates space as a data buffer for storing messages that are received through ports corresponding to different types of networks, and are to be sent out through ports corresponding to different types of networks. The DRAM 330 further stores necessary data in execution, such as variables, flags, data tables, and so on. The PON MAC 340 is coupled to a corresponding circuitry of the physical layer 370 for driving the corresponding circuitry (may include an optical receiver and an optical transmitter) to generate a series of optical signal interchanges with the OLT 230, so as to receive and transmit packets from and to the OLT 230 through the optical link. The Ether MAC 350 is coupled to a corresponding circuitry of the physical layer 370 for driving the corresponding circuitry (may include a digital receiver and a digital transmitter) to generate a series of electrical signal interchanges with the user device 250, so as to receive and transmit packets from and to the user device 250 through the Ether link. The PCIE MAC 360 is coupled to a corresponding circuitry of the physical layer 370 for driving the corresponding circuitry (may include a radio frequency(RF) receiver and an RF transmitter) to generate a series of Rp signal interchanges with the user device 250, so as to receive and transmit packets from and to the user device 250 through the wireless link. The wireless link may be established with a wireless communications protocol, such as 802.11x, Bluetooth, etc.

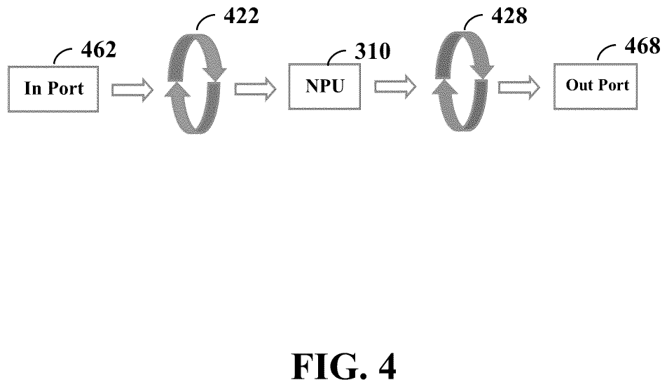

Refer to FIG. 4 showing a schematic diagram for processing messages. The DRAM 330 may allocate space for one or more input ring buffers 422 to store packets received through the input port 462. The DRAM 330 may allocate space for one or more output ring buffers 428 to store packets to be transmitted out through the output port 468. The physical layers 370 includes multiple input ports 462, multiple output ports 468 and different types of receivers and transmitters.

For example, one input port 462 is coupled to the optical receiver, and the optical receiver is coupled to the optical transmitter of the OLT 230, so that the PON MAC 340 repeatedly receives packets from the OLT 230 through this input port 462 and pushes the received packets into the corresponding input ring buffer 422. Another input port 462 is coupled to the digital receiver, and the digital receiver is coupled to the Ethernet hub, so that the Ether MAC 350 repeatedly receives packets from the user devices 250 through this input port 462 and pushes the received packets into the corresponding input ring buffer 422. Still another input port 462 is coupled to the WiFi RF receiver for allowing the PCIE MAC 360 to repeatedly receive packets transmitted from the user devices 250 from the medium through this input port 462 and push the received packets into the corresponding input ring buffer 422. Further another input port 462 is coupled to the Bluetooth RF receiver for allowing the PCIE MAC 360 to repeatedly receive packets transmitted from the user devices 250 from the medium through this input port 462 and push the received packets into the corresponding input ring buffer 422.

For example, one output port 468 is coupled to the optical transmitter, and the optical transmitter is coupled to the optical receiver of the OLT 230, so that the PON MAC 340 repeatedly pops designated packets out of the corresponding output ring buffer 428 and drives the optical transmitter to transmit the packets to the OLT 230 through this output port 468. Another output port 468 is coupled to the digital transmitter, and the digital transmitter is coupled to the Ethernet hub, so that the Ether MAC 350 repeatedly pops designated packets out of the corresponding output ring buffer 428 and drives the digital transmitter to transmit the packets to the user devices 250 through this output port 468. Still another output port 468 is coupled to the WiFi RF transmitter for allowing the PCIE MAC 360 to repeatedly pop designated packets out of the corresponding output ring buffer 428 and drive the WiFi RF transmitter to transmit the packets with the WiFi communications protocol to the user devices 250 through this output port 468. Further another output port 468 is coupled to the Bluetooth RF transmitter for allowing the PCIE MAC 360 to repeatedly pop designated packets out of the corresponding output ring buffer 428 and drive the Bluetooth RF transmitter to transmit the packets with the Bluetooth communications protocol to the user devices 250 through this output port 468.

The NPU may execute a critical algorithm composed of software instructions for repeatedly popping packets out of the input ring buffer 422, decapsulating the popped packets according to a designated packet format corresponding to the input port through which the popped packets have been received, to obtain the source address, destination address and message, encapsulating the obtained source address, destination address and message according to a designated packet format into packets corresponding to the output port through which the packets to be sent out, and pushing the encapsulated packets into the output ring buffer 428. The source and destination addresses are Internet Protocol (IP) addresses. In one example, the critical algorithm pops the packets received from the OLT 230 out of the input ring buffer 422, parses the source address, destination address and message from the popped packets according to the packet format employed in the optical link and knows that the obtained message needs to be transmitted, through the Ethernet, to the designated user device 250 by indexing the mapping table with the obtained destination address. The critical algorithm then encapsulates the source address, destination address and message into packets according to the packet format employed in the Ether link and pushes the encapsulated packets into the output ring buffer 428, thereby enabling the Ether MAC 350 to transmit the packets to the Local Area Network (LAN) through its digital transmitter. In another example, the critical algorithm pops the packets received from the user device 250 out of the input ring buffer 422, parses the source address, destination address and message from the popped packets according to the packet format employed in the Bluetooth link and knows that the obtained message needs to be transmitted, through the optical link, to devices on the Internet 210 by indexing the mapping table with the obtained destination address. The critical algorithm then encapsulates the source address, destination address and message into packets according to the packet format employed in the optical link and pushes the encapsulated packets into the output ring buffer 428, thereby enabling the PON MAC 340 to transmit the packets to the Internet 210 through its optical transmitter. The NPU 310 when executing the critical algorithm may involve the manipulation of various hardware devices, such as a cache or a Static Random Access Memory (SRAM) in the NPU 310, the CPU 320, the DRAM 330, the PON MAC 340, the Ether MAC 350, the PCIE MAC 360, or any combinations thereof.

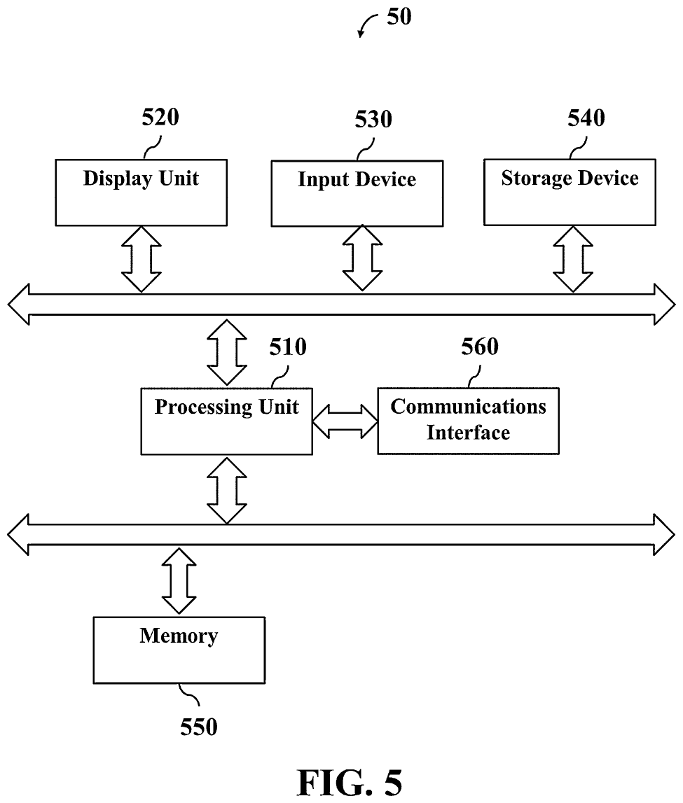

Before the critical algorithm runs on the NPU 310 of the ONU router 20, an analysis equipment may be employed to analyze the critical algorithm and the critical algorithm is optimized according to the analysis results. Refer to FIG. 5 showing the system architecture of the analysis equipment 50. The system architecture may be implemented in a PC, a workstation or a laptop PC, at least including the processing unit 510. The processing unit 510 may be implemented in numerous ways, such as with general-purpose hardware (e.g., a single processor, multiple processors or graphics processing units capable of parallel computations, or others) that is programmed using software instructions to perform the functions recited herein. The system architecture further includes the memory 550 and the storage device 540. The memory 550 stores necessary data in the execution of analysis program, such as executable codes, variables, data tables, and so on for the critical algorithm. The storage device 540 may be a hard drive, a Solid-State Drive (SSD), a flash memory stick, or others, to store a wide range of digital files. The communications interface 560 may be included in the system architecture and the processing unit 510 can thereby communicate with the other electronic equipment. The communications interface 560 may be a wireless telecommunications module, a local area network (LAN) module or a wireless local area network (WLAN) module. The wireless telecommunications module may be equipped with the MODEM that supports 2G/3G/4G/5G, a higher technology generation, or any combinations thereof. The system architecture may include the input devices 530 to receive user input, such as a keyboard, a mouse, a touch panel, or others. A user (such as a software developer or a testing engineer of the critical algorithm) may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. The display unit 520, such as a Thin Film Transistor Liquid-Crystal Display (TFT-LCD) panel, an Organic Light-Emitting Diode (OLED) panel, or others, may also be included in the system architecture to display input letters, alphanumeric characters and symbols, dragged paths, drawings, or screens provided by an application for the user to view.

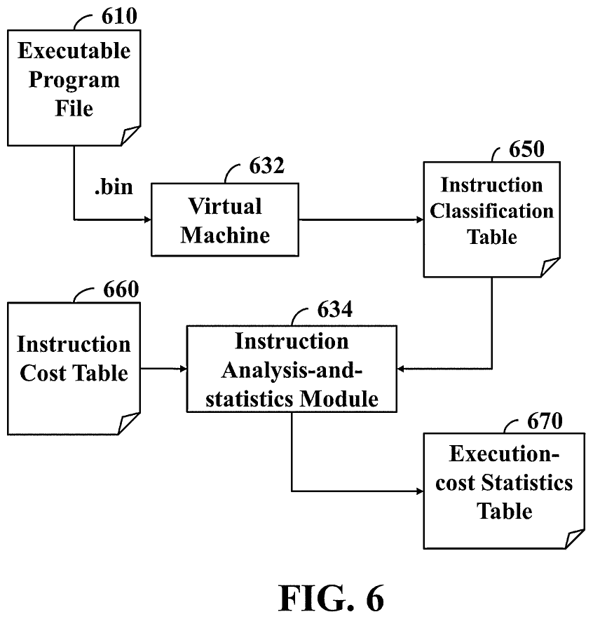

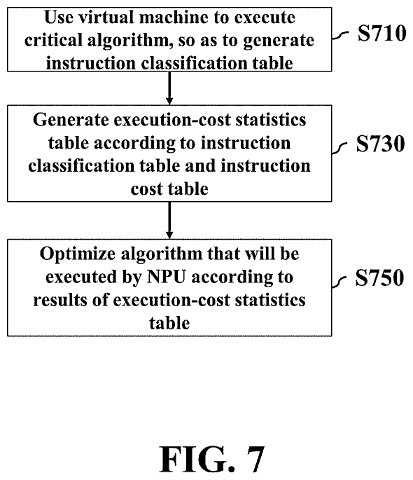

An embodiment of the present invention introduces a method for analyzing algorithms designed for running on the NPU by predicting the performance of the critical algorithm in advance, rather than measuring the performance of the critical algorithm actually running on the NPU 310 of the ONU router 20. Moreover, in the analysis method introduced by an embodiment of the present invention, the minimum analysis unit is one instruction in the execution of the critical algorithm. Those artisans would understand that multiple instructions are executed typically when the NPU 310 fetches and executes each code line, and the granularity level of the optimum manner as shown in FIG. 1 is rougher than that of the analysis method introduced by an embodiment of the invention. Refer to the software architecture for a simulated instruction analysis as shown in FIG. 6 and the method for analyzing an algorithm based on simulated instructions as shown in FIG. 7. The details are described as follows:

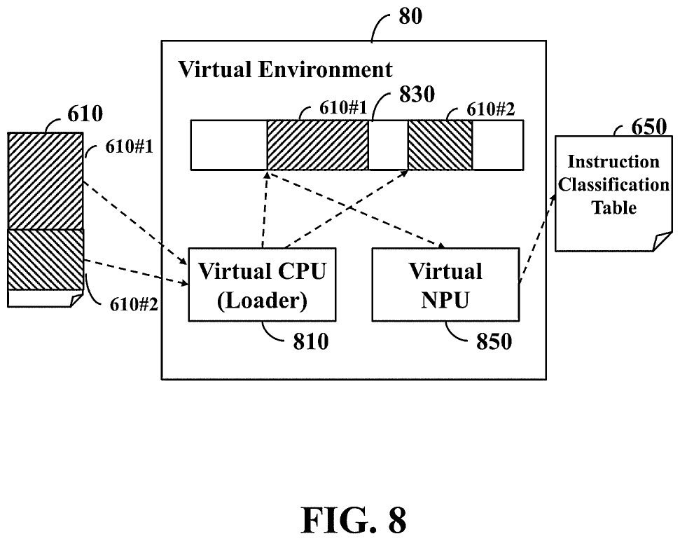

Step S710: The executable program file 610 (for example, npu.bin) is loaded and executed on the virtual machine 632, and the executable program file 610 includes a critical algorithm that will run on the NPU 310 after the ONU router 20 leaves the factory in the future. The virtual machine 632 runs on the processing unit 510 of the analysis equipment 50 to create a virtual environment for simulating the hardware components in the ONU router 20. Refer to FIG. 8 illustrating the execution simulation in the virtual environment. The executable program file 610 includes two parts: program code 610 #1 and data 610 #2. The virtual environment simulated by the virtual machine 632 includes the virtual CPU 810 (corresponding to the CPU 320), virtual DRAM 830 (corresponding to the DRAM 330) and virtual NPU 850 (corresponding to the NPU 310). The virtual CPU 810 executes the loader for storing the code 610 #1 in the executable program file 610 in the first region (in slashes) of the virtual DRAM 830 and storing the data 610 #2 in the executable program file 610 in the second region (in back slashes). The virtual NPU 850 fetches and executes the instructions of the executable program file 610 from the starting address of the first region. During the execution of the executable program file 610 by the virtual NPU 850, the instruction classification table 650 is generated to include multiple records and each record corresponds to the execution of one instruction. Then, the instruction classification table 650 is stored in the RAM 550 and/or the storage device 540 for subsequent analysis.

The instructions may be classified into ten different categories: cache-read instruction; cache-write instruction; SRAM-read instruction; SRAM-write instruction; DRAM-read instruction; DRAM-write instruction; Input/Output (I/O)-read instruction; I/O-write instruction; regular calculation instruction; and special function instruction. The instructions for reading data from the L1 cache in the NPU 310 are classified as the cache-read instruction category. The instructions for writing data into the L1 cache in the NPU 310 are classified as the cache-write instruction category. The instructions for reading data from the SRAM in the NPU 310 are classified as the SRAM-read instruction category. The instructions for writing data into the SRAM in the NPU 310 are classified as the SRAM-write instruction category. The instructions for reading data from the DRAM 330 are classified as the DRAM-read instruction category. The instructions for writing data into the DRAM 330 are classified as the DRAM-write instruction category. The instructions for obtaining data by driving the PON MAC 340, the Ether MAC 350 and the PCIE MAC 360 are classified as the I/O-read instruction category. The instructions for transmitting data by driving the PON MAC 340, the Ether MAC 350 and the PCIE MAC 360 are classified as the I/O-write instruction category. The instructions for performing typical arithmetic and logical operations (e.g. addition, subtraction, multiplication, division, logical OR, logical AND, logical NOT, logical XOR, etc.) are classified as the regular calculation instruction category. The instructions for performing special functions (e.g. functions of parity check, encryption, decryption, etc.) are classified as the special function instruction category. Those artisans may use more or fewer instruction categories to represent different types of instruction executions depending on different system requirements, and the invention should not be limited thereto. The instruction classification table 650 includes information about actually executed instructions, the classified categories, and others. Table 1 shows the exemplary instruction classification table 650 as follows:

TABLE 1

| Instruction | Category |
|---|---|
| Load R1, Mem0 | Cache-read Instruction |
| Store R2, Mem1 | Cache-write Instruction |
| Add R1, R2 | Regular Calculation Instruction |
| . | . |
| . | . |
| . | . |

During the execution of the executable program file 610, at least three instructions are detected and are classified as the categories of cache-read instruction, the cache-write instruction and the regular calculation instruction, respectively.

Step S730: The processing unit 510 executes the program code of the instruction analysis-and-statistics module 634 to generate the execution-cost statistics table 670 according to the instruction classification table 650 and the instruction cost table 660. The instruction cost table 660 includes ten records and each record stores the regular cost of one instruction related to each instruction category during its execution. Table 2 shows the exemplary instruction cost table 660 as follows:

TABLE 2

| Category | Execution Cost |
|---|---|
| Cache-read Instruction | Cost#1 |
| Cache-write Instruction | Cost#2 |
| SRAM-read Instruction | Cost#3 |
| SRAM-write Instruction | Cost#4 |
| DRAM-read Instruction | Cost#5 |
| DRAM-write Instruction | Cost#6 |
| I/O-read Instruction | Cost#7 |
| I/O-write Instruction | Cost#8 |
| Regular calculation Instruction | Cost#9 |
| Special Function Instruction | Cost#10 |

The execution costs Cost #1 to Cost #10 may be expressed as the total number of clock cycles, indicating how many clock cycles are substantially required for the execution of an instruction in a designated category. Those artisans may store more or fewer records in the instruction cost table 660 according to the actual number of instruction categories, and the invention should not be limited thereto. The content of instruction cost table 660 may be generated according to the past experience in operating the ONU router 20, which is regarded as the theoretical cost for executing an instruction classified as a designated instruction category.

The execution-cost statistics table 670 stores the summarized cost of the executed instructions for each instruction category during the execution of critical algorithm. Table 3 shows the exemplary execution-cost statistics table 670 as follows:

TABLE 3

| Category | Instruction Count | Sum of Execution Cost |
|---|---|---|
| Cache-read Instruction | Cnt#1 | Cnt#1 * Cost#1 |
| Cache-write Instruction | Cnt#2 | Cnt#2 * Cost#2 |
| SRAM-read Instruction | Cnt#3 | Cnt#3 * Cost#3 |
| SRAM-write Instruction | Cnt#4 | Cnt#4 * Cost#4 |
| DRAM-read Instruction | Cnt#5 | Cnt#5 * Cost#5 |
| DRAM-write Instruction | Cnt#6 | Cnt#6 * Cost#6 |
| I/O-read Instruction | Cnt#7 | Cnt#7 * Cost#7 |
| I/O-write Instruction | Cnt#8 | Cnt#8 * Cost#8 |
| Regular calculation Instruction | Cnt#9 | Cnt#9 * Cost#9 |
| Special Function Instruction | Cnt#10 | Cnt#10 * Cost#10 |

The instruction counts Cn#1 to Cnt#1 indicate the numbers of instructions related to the ten categories in the executable program file 610. The “Sum of Execution Cost” column in the execution-cost statistics table 670 stores the multiplications of the theoretical costs and the executed instruction numbers for the ten categories. The sum of execution cost for each instruction category may be calculated by a formula as follows:

totalCost #i=Cnt#i*Cost #i

totalCost #i represents the sum of execution cost for the i^{th} instruction category, Cnt #i represents the total number of executed instructions related to the i^{th} instruction category, Cost #i represents the theoretical cost of the i^{th} instruction category, i is an integer greater than zero, and less than or equal to N, N represents the total number of instruction categories.

Step S750: The critical algorithm that will be executed by the NPU 310 is optimized according to the results of the execution-cost statistics table 670. For example, each instruction category with high time-consuming are marked according to the results of the execution-cost statistics table 670, and then, the instructions classified as the high time-consuming instruction categories are optimized. Optimization methods may be classified into software optimization and hardware optimization.

For example, the software optimization for the high time-consuming instruction categories may include the following approaches: removing redundant data structures and the procedures dealing with the redundant ones from the source code. The resources (e.g., DRAM space, etc.) shared by multiple tasks are modified as multiple independent resources, each of which is dedicated to one or more tasks, so as to reduce the control operations for locking and unlocking the resources. The times for driving the PON MAC 340, Ether MAC 350 and PCIE MAC 360 are reduced, for example, ad hoc and light-volume message delivering tasks are changed to fixed-length message delivering tasks in batches.

For example, the hardware optimization for the high time-consuming instruction categories may include the following approaches: increasing more SRAM space in the NPU 310 to store as many variables, messages, data tables and so on, which are required during the execution of critical algorithm, as possible in the SRAM since the time-consuming for accessing to the SRAM is lower than that to the DRAM.

Some or all of the aforementioned embodiments of the method of the invention may be implemented in a computer program, such as a driver of a dedicated hardware, an application in a specific programming language, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier such as a DVD, CD-ROM, USB stick, a hard disk, which may be located in a network server accessible via a network such as the Internet, or any other suitable carrier.

Although the embodiment has been described as having specific elements in FIGS. 3 and 5, it should be noted that additional elements may be included to achieve better performance without departing from the spirit of the invention. Each element of FIGS. 3 and 5 is composed of various circuitries and arranged to operably perform the aforementioned operations. While the process flows described in FIG. 7 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for analyzing an algorithm designed for running on a network processing unit (NPU), performed by a processing unit, comprising:
loading and executing an executable program file on a virtual machine, wherein the executable program file comprises the algorithm that can be executed by the NPU;
generating an instruction classification table during an execution of the executable program file, wherein the instruction classification table stores information about a plurality of instructions that have been executed on the virtual machine, and which instruction category each instruction is related to; and
generating an execution-cost statistics table according to the instruction classification table and an instruction cost table, thereby enabling the algorithm to be optimized according to content of the execution-cost statistics table,
wherein the instruction cost table stores a plurality of costs, in which each cost is related to a designated instruction category,
wherein the execution-cost statistics table stores a summarized cost of executed instructions for each instruction category.

2. The method of claim 1, wherein the virtual machine creates a virtual environment for simulating hardware components in an Optical Network Unit (ONU) router.

3. The method of claim 2, wherein the ONU router comprises the NPU, and the processing unit is installed in an analysis equipment other than the ONU router.

4. The method of claim 3, wherein the algorithm runs on the NPU to repeatedly receive messages through an input port of the ONU router and transmit the messages out to a target equipment through an output port of the ONU router.

5. The method of claim 1, wherein the cost is expressed as a total number of clock cycles.

6. The method of claim 5, wherein the summarized cost of executed instructions for each instruction category is calculated by a formula as follows:
totalCost #i=Cnt#i*Cost #i
totalCost #i represents the summarized cost of executed instructions for i^{th} instruction category, Cnt #i represents a total number of executed instructions related to the i^{th} instruction category, Cost #i represents a theoretical cost of the i^{th} instruction category, i is an integer greater than zero, and less than or equal to N, N represents a total number of instruction categories.

7. The method of claim 1, wherein the instruction categories comprise: cache-read instruction; cache-write instruction; SRAM-read instruction; SRAM-write instruction; DRAM-read instruction; DRAM-write instruction; Input/Output (I/O)-read instruction; I/O-write instruction; regular calculation instruction; and special function instruction.

8. A non-transitory computer-readable storage medium having stored therein program code that, when loaded and executed by a processing unit, cause the processing unit to perform a method for analyzing an algorithm designed for running on a network processing unit (NPU) therein to:
load and execute an executable program file on a virtual machine, wherein the executable program file comprises the algorithm that can be executed by the NPU;
generate an instruction classification table during an execution of the executable program file, wherein the instruction classification table stores information about a plurality of instructions that have been executed on the virtual machine, and which instruction category each instruction is related to; and
generate an execution-cost statistics table according to the instruction classification table and an instruction cost table, thereby enabling the algorithm to be optimized according to content of the execution-cost statistics table,
wherein the instruction cost table stores a plurality of costs, in which each cost is related to a designated instruction category,
wherein the execution-cost statistics table stores a summarized cost of executed instructions for each instruction category.

9. The non-transitory computer-readable storage medium of claim 8, wherein the virtual machine creates a virtual environment for simulating hardware components in an Optical Network Unit (ONU) router.

10. The non-transitory computer-readable storage medium of claim 9, wherein the ONU router comprises the NPU, and the processing unit is installed in an analysis equipment other than the ONU router.

11. The non-transitory computer-readable storage medium of claim 10, wherein the algorithm runs the NPU to repeatedly receive messages through an input of in the ONU router and transmit the messages out to a target equipment through an output port of the ONU router.

12. The non-transitory computer-readable storage medium of claim 8, wherein the cost is expressed as a total number of clock cycles.

13. The non-transitory computer-readable storage medium of claim 12, wherein the summarized cost of executed instructions for each instruction category is calculated by a formula as follows:
totalCost #i=Cnt#i*Cost #i
totalCost #i represents the summarized cost of executed instructions for i^{th} instruction category, Cnt #i represents a total number of executed instructions related to the i^{h} instruction category, Cost #i represents a theoretical cost of the i^{th} instruction category, i is an integer greater than zero, and less than or equal to N, N represents a total number of instruction categories.

14. An apparatus for analyzing an algorithm designed for running on a network processing unit (NPU), comprising:
a processing unit, arranged operably to: load and execute an executable program file on a virtual machine, wherein the executable program file comprises the algorithm that can be executed by the NPU; generate an instruction classification table during an execution of the executable program file, wherein the instruction classification table stores information about a plurality of instructions that have been executed on the virtual machine, and which instruction category each instruction is related to; and generate an execution-cost statistics table according to the instruction classification table and an instruction cost table, thereby enabling the algorithm to be optimized according to content of the execution-cost statistics table,
wherein the instruction cost table stores a plurality of costs, in which each cost is related to a designated instruction category,
wherein the execution-cost statistics table stores a summarized cost of executed instructions for each instruction category.

15. The apparatus of claim 14, wherein the virtual machine creates a virtual environment for simulating hardware components in an Optical Network Unit (ONU) router.

16. The apparatus of claim 15, wherein the ONU router comprises the NPU, and the processing unit is installed in an analysis equipment other than the ONU router.

17. The apparatus of claim 16, wherein the algorithm runs on the NPU to repeatedly receive messages through an input port of the ONU router and transmit the messages out to a target equipment through an output port of the ONU router.

18. The apparatus of claim 14, wherein the cost is expressed as a total number of clock cycles.

19. The apparatus of claim 18, wherein the summarized cost of executed instructions for each instruction category is calculated by a formula as follows:
totalCost #i=Cnt#i*Cost #i
totalCost #i represents the summarized cost of executed instructions for i^{th} instruction category, Cnt #i represents a total number of executed instructions related to the i^{th} instruction category, Cost #i represents a theoretical cost of the i^{th} instruction category, i is an integer greater than zero, and less than or equal to N, N represents a total number of instruction categories.

20. The apparatus of claim 14, wherein the instruction categories comprise: cache-read instruction; cache-write instruction; SRAM-read instruction; SRAM-write instruction; DRAM-read instruction; DRAM-write instruction; Input/Output (1/O)-read instruction; I/O-write instruction; regular calculation instruction; and special function instruction.
